(19) United States
(12) Patent Application Publication
(10) Pub. No.: US 2019/0193258 A1
(43) Pub. Date: Jun. 27, 2019

(54) TOOL STORAGE DEVICE

(71) Applicant: YUAN LI HSING INDUSTRIAL CO., LTD., Taichung City (TW)

(72) Inventors: Hui-Chien Chen, Taichung City (TW); Chia-Yi Chen, Taichung City (TW)

(21) Appl. No.: 15/850,767

(22) Filed: Dec. 21, 2017

(51) Int. Cl. B25H 3/02; B60R 11/06

(52) U.S. Cl. CPC B25H 3/022; B25H 3/003; B60R 11/06

(57) ABSTRACT

A tool storage device is provided, including: a flexible substrate, having a mounting surface; at least one tool storage member, each of the at least one tool storage member including a base which is attached to the mounting surface and at least one tool seat slidably disposed on the base; wherein the flexible substrate is foldable to form a storage space for storing the at least one tool storage member therein.

### BACKGROUND OF THE INVENTION

### Field of the Invention

The present invention relates to a tool storage device.

### Description of the Prior Art

Generally, the condition tool storage device includes a track base configured for slidably assembling of a plurality of socket holders; each of the socket holders has a locking member for engaging with the cavity of a socket to storage and label. However, users often need a number of tools to achieve their purpose of work, so a more diversified storage structure is needed for storing tools and the volume of the storage device also need to be reduced for being portable. In addition, it is also an urgent problem to prevent the tools from being squeezed, collided, and scattered in the storage device.

The present invention is, therefore, arisen to obviate or at least mitigate the above mentioned disadvantages.

### SUMMARY OF THE INVENTION

An object of the present invention is to provide a tool storage device, in which at least one tool is adjustable in position.

To achieve the above and other objects, a tool storage device is provided, including: a flexible substrate, having a mounting surface; at least one tool storage member, each of the at least one tool storage member including a base which is attached to the mounting surface and at least one tool seat slidably disposed on the base; wherein the flexible substrate is foldable to form a storage space for storing the at least one tool storage member therein.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a tool storage device with a part thereof folded according to a preferred embodiment of the present invention;

FIG. 2 is another stereogram of the tool storage device unfolded according to a preferred embodiment of the present invention;

FIG. 3 is another stereogram of the tool storage device with a corner part thereof rolled according to a preferred embodiment of the present invention;

FIG. 4 is a partial cross-sectional view of a tool storage member according to a preferred embodiment of the present invention;

FIG. 5 is another stereogram of the tool storage device completely folded according to a preferred embodiment of the present invention;

FIG. 6 is a breakdown drawing of a tool storage member according to a preferred embodiment of the present invention;

FIG. 7 is a breakdown drawing of a tool storage member according to another preferred embodiment of the present invention.

### DETAILED DESCRIPTION OF THE PREFERRED IN THIS EMBODIMENTS

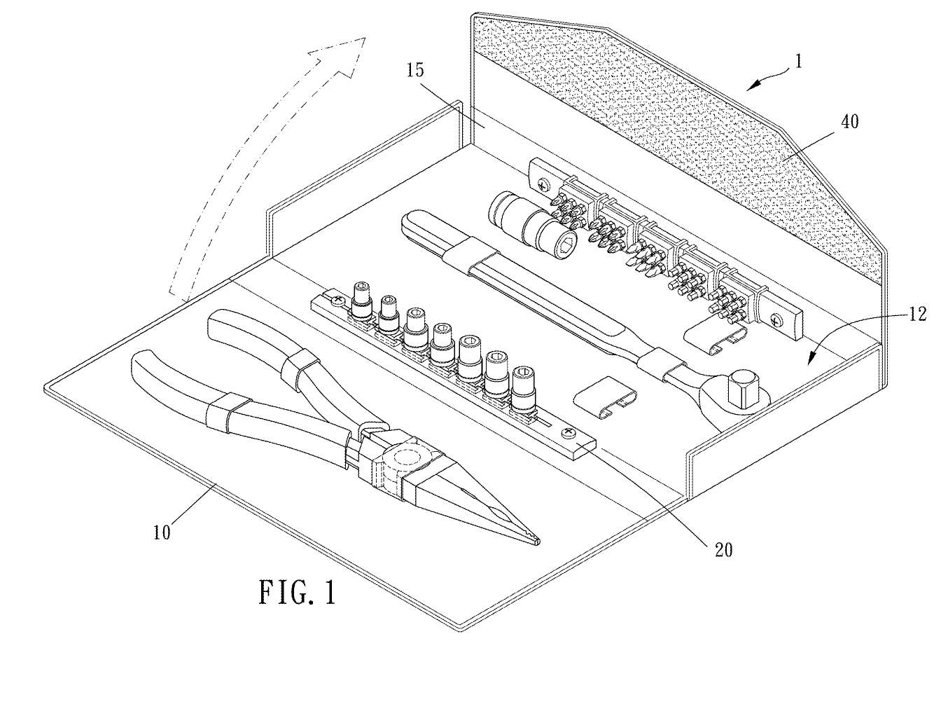

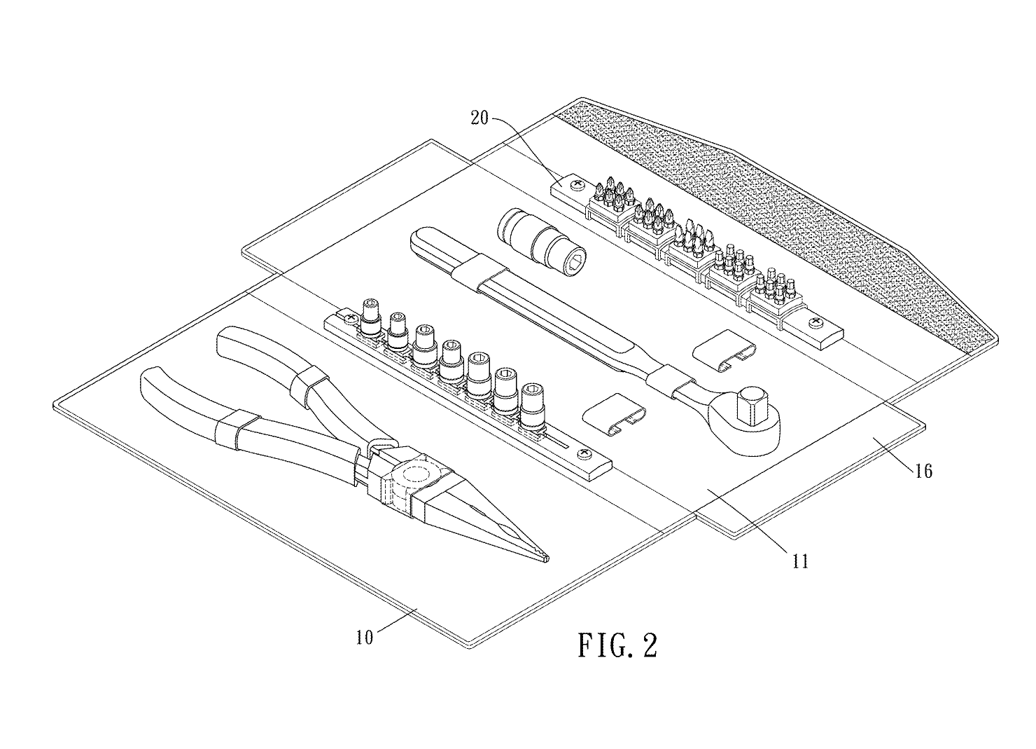

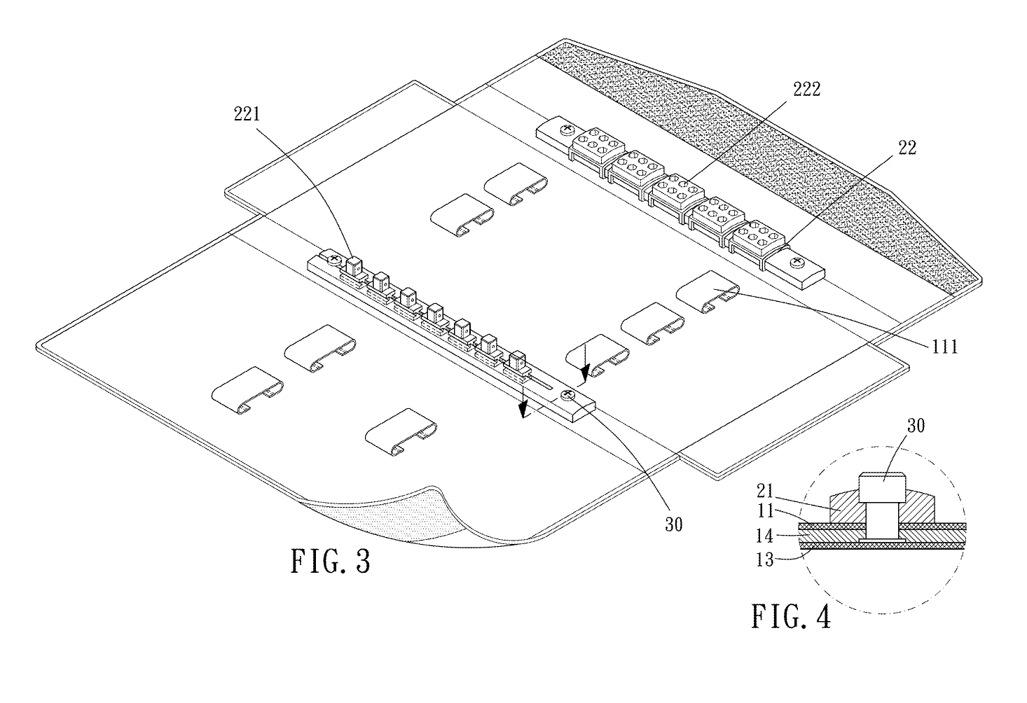

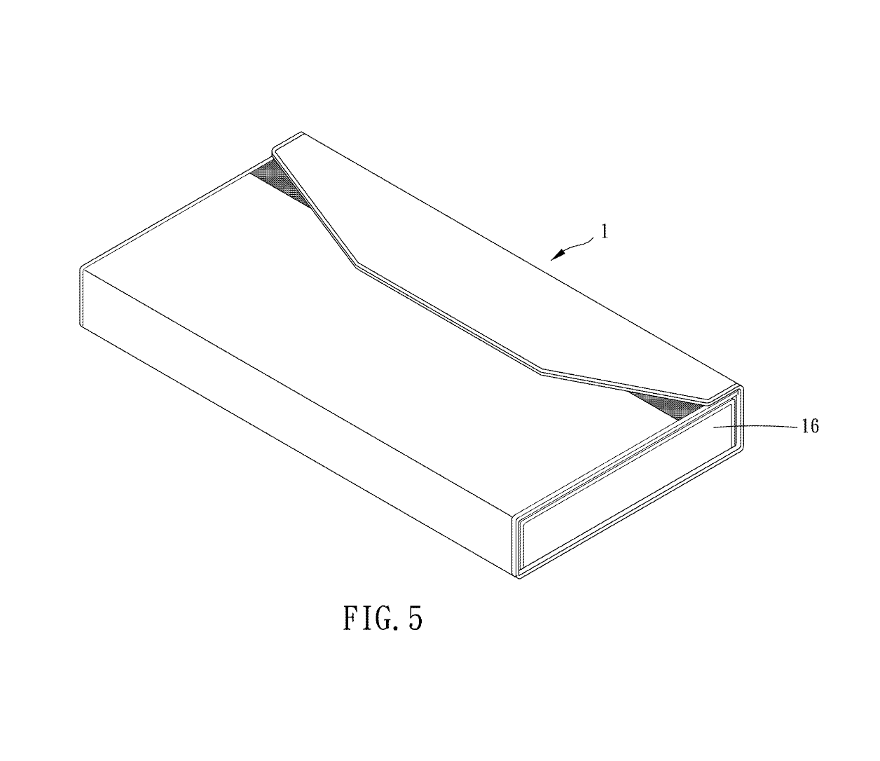

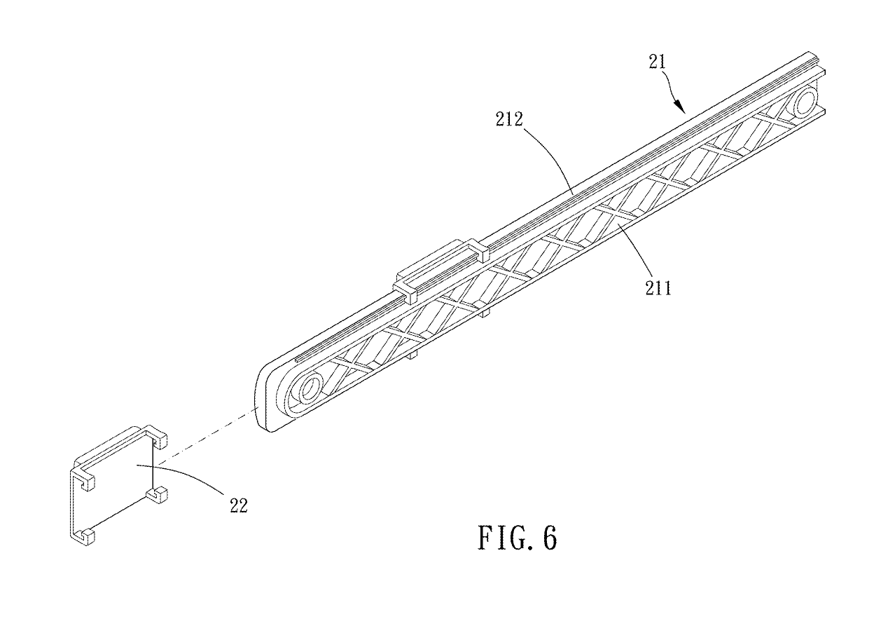

FIGS. 1 to 7, show a tool storage device according to a preferred embodiment of the present invention. The tool storage device 1 includes a flexible substrate 10 and at least one tool storage member 20.

The flexible substrate 10 has a mounting surface 11; each of the at least one tool storage member 20 includes a base 21 which is attached to the mounting surface 11 and at least one tool seat 22 slidably disposed on the base 21; wherein the flexible substrate 10 is foldable to form a storage space 12 for storing the at least one tool storage member 20 therein. Therefore, the at least one tool is adjustable in position.

In this embodiment, the base 21 includes a lower portion 211 attached to the mounting surface 11 and an upper rail 212 disposed on the lower portion 211, the upper rail 212 protrudes laterally beyond the lower portion 211, and the tool seat 22 is slidably disposed on the upper rail 212. The upper rail 212 and the mounting surface 11 are spaced apart from each other so that the tool seat 22 can slide smoothly on the upper rail 212.

Specifically, the at least one tool seat 22 includes at least one socket seat 221 configured for assembling of at least one socket or at least one hole 222 configured for receiving at least one tool head. Preferably, the tool storage member 20 is releasably or detachably attached to the mounting surface 11; for instance, one end or both ends of the tool storage member 20 are releasably or detachably connected, buckled, or locked on the mounting surface 11 so that the tool storage member 20 may be disassembled from the mounting surface 11 according to various requirements. It is possible to increase or decrease a number of the tool seat 22 and/or to change the type of the tool seat 22, thus improving the capacity and diversity for tool storage. Preferably, a number of the at least one tool seat 22 is plural, and adjacent two of the tool seats 22 are abuttable against each other to increase the storage space. For example, there are two tool storage members 20 attached to the mounting surface 11 and spaced apart from each other, one of the two tool storage members 20 has a plurality of tool seats 22 with the socket seats 221, and the other of the two tool storage members 20 has a plurality of tool seats 22 with the holes 222. It is noted that each tool seat of each of the tool storage members may be configured to ha the socket seat and the hole.

The flexible substrate 10 further includes at least one (preferably plural) assembling portion 111 which is disposed on the mounting surface 11 configured to receive at least one tool (such as screwdriver or wrench, etc), thus increasing storage capacities. Each of the tool seats 22 is slidable and adjustable so that it would not collide with the tools on the assembling portion 111, thus reducing the volume of the tool storage device 1 folded and being more convenience.

Preferably, the flexible substrate 10 further includes an outer layer 13 and a plate 14 disposed between the mounting surface 11 and the outer layer 13, and each base 21 of each tool storage members 20 is connected to the plate 14 with at least one connecting member 30 disposed through the mounting surface 11, so as to increase the stability of the tool storage members 20 and the configuration of the tool storage device 1. The flexible substrate 10 is foldable along the at least one tool storage member 20 to form at least one sidewall 15. In this embodiment, the flexible substrate 10 is foldable along the two tool storage members 20 which are spaced apart from each other to form two sidewalls 15, thus reducing the volume of the tool storage device 1 and preventing the tools from colliding to each other by adjusting positions of the tool seats 22.

Furthermore, one end of the flexible substrate 10 may be provided with a fastening member 40 (such as a magnetic clasp or a Velcro, etc) integrally extending therefrom or connected thereto. As the flexible substrate 10 is folded, the fastening member 40 can be attached to the other end of the flexible substrate 10, so as to keep the tool storage device 1 in a stable configuration and avoid dropping of the tools. In addition, the flexible substrate 10 may have two wins 16 so that the tools will not fall out easily from the folded tool storage device 1 and the storage space 12 can also be stabilized.

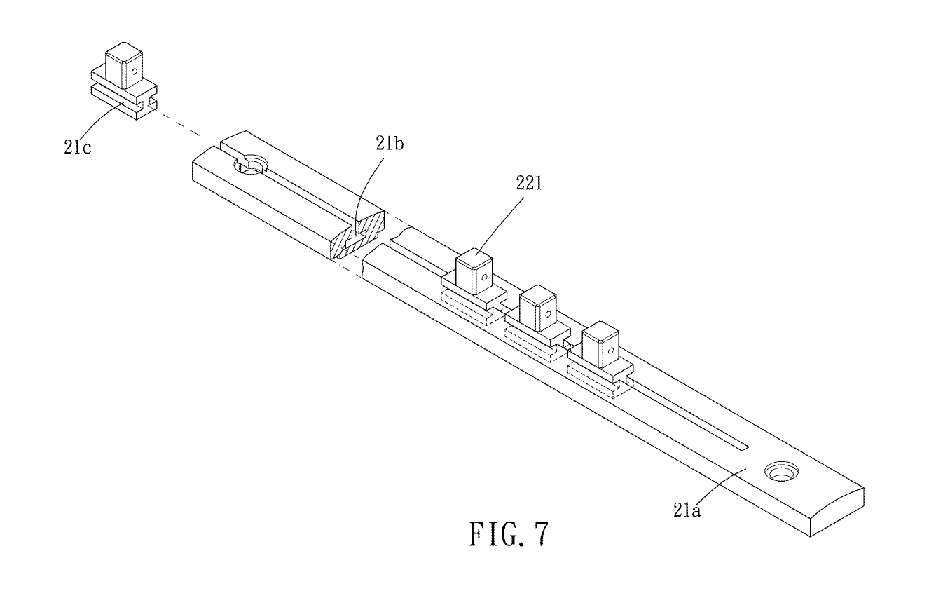

In other embodiment as shown in FIG. 7, the base 21a has an elongate slot 21b, the tool seat 22 has a leg 21c slidably engaged with the elongate slot 21b, and the tools are also adjustable in position.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool storage device, including:
a flexible substrate, having a mounting surface;
at least one tool storage member, each of the at least one tool storage member including a base which is attached to the mounting surface and at least one tool seat slidably disposed on the base;
wherein the flexible substrate is foldable to form a storage space for storing the at least one tool storage member therein.

2. The tool storage device of claim 1, wherein the base includes a lower portion attached to the mounting surface and an upper rail disposed on the lower portion, the upper rail protrudes laterally beyond the lower portion, and the tool seat is slidably disposed on the upper rail.

3. The tool storage device of claim 1, wherein the base has an elongate slot, the tool seat has a leg slidably engaged with the elongate slot.

4. The tool storage device of claim 1, wherein the at least one tool seat includes at least one socket seat configured for assembling of at least one socket.

5. The tool storage device of claim 1, wherein the at least one tool seat includes at least one hole configured for receiving at least one tool head.

6. The tool storage device of claim 1, wherein the tool storage member is releasably attached to the mounting surface.

7. The tool storage device of claim 1, wherein a number of the at least one tool seat is plural, and adjacent two of the tool seats are abuttable against each other.

8. The tool storage device of claim 1, wherein the flexible substrate further includes at least one assembling portion which is disposed on the mounting surface configured to receive at least one tool.

9. The tool storage device of claim 1, wherein the flexible substrate further includes an outer layer and a plate disposed between the mounting surface and the outer layer, and the base of each tool storage member is connected to the plate with at least one connecting member disposed through the mounting surface.

10. The tool storage device of claim 1, wherein the flexible substrate is foldable along the at least one tool storage member to form at least one sidewall.
